(19) United States
(12) Patent Application Publication
(10) Pub. No.: US 2005/0108234 A1
(43) Pub. Date: May 19, 2005

(54) Speed browsing of media items in a media diary application

(75) Inventors: Olli Oksanen, Helsinki (FI); Christian Lindholm, Helsinki (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/715,095

(22) Filed: Nov. 17, 2003

(51) Int. Cl. G06F 7/00

(52) U.S. Cl. 707/9

(57) ABSTRACT

A media management application implemented in a digital device that incorporates a speed browsing mechanism. The speed browsing mechanism provides for the speed of the browsing or scrolling function to be altered depending on the desire of the user. The speed browser can be configured by the user to browse for time periods, specific types of media files, annotated or bookmarked media files or any other user designated browse-able parameter. The speed browsing mechanism of the present invention provides the device user with a highly efficient means of locating time periods and the media files associated with the time periods. In addition, the speed browsing mechanism provides ergonomic benefit to the user, in that, user inputs to the device are limited and the user inputs that are required are user-friendly.

### FIELD OF THE INVENTION

The present invention relates to digital storage and management of media files and, more specifically, to a media file management application that incorporates a browsing mechanism for locating media files.

### BACKGROUND OF THE INVENTION

The rapid growth of digital communication has made it possible for all kinds of digital media items to be communicated amongst various types of wireless and wire line communication devices. For instance, the cellular or mobile telephone is no longer limited to telephonic voice communication and may include other means of digital communication, such as digital networking (i.e., Internet communication, text messaging, and the like). In addition, an increasing number of cellular telephones and other mobile wireless communication devices, such as portable computers, personal data assistants (PDAs) and the like, are being integrated with other means of capturing or producing digital media, such as digital cameras, digital audio recorders, digital video recorders and the like. Technological advances have made it possible for other digital devices, such as digital cameras, digital video recorders, digital audio devices and the like to be equipped with means for digital communication. As more and more digital devices possess the capability to digitally communicate with one another, the amount of digital media items that will be communicated amongst these devices will increase at an alarming rate.

In addition to the onset of more and more digital devices possessing digital communication capabilities, the digital storage capacity of these devices is constantly increasing. In the near future the majority of mobile digital communication terminals may well be equipped with storage capacity in the gigabyte range or greater, allowing these devices to store an enormous amount of digital data. In this environment it will no longer be prohibitive from a memory capacity standpoint to store a voluminous amount of large file types, such as video, audio or other multimedia files.

In the digital communication environment where more and more digital devices, both wireless and wired, are equipped with a means for digital communication and where the storage capacity of these devices has become seemingly endless, the digital communication device will encounter and store innumerable digital media files. As such, the digital communication device will desire a means to access, store, manage and further communicate these digital files in an efficient and user-friendly environment.

For example, if a digital communication device receives a digital media file the user of the device would benefit greatly from an application that automatically places the file into a readily accessible storage area and where managing and accessing of the file in the future can occur efficiently, without the user having to spend a great deal of time searching for the media file.

Most digital communication devices, such as desktop or laptop computers, personal data assistants (PDAs) or the like either come equipped or can be configured by the user to implement a daily planner application. The daily planner allows the user coordinate and manage their upcoming schedule of events by inputting event reminders in a digital calendar. The digital planner provides the unique benefit of sending the user electronic reminders, in the form of alarms or visual or audible messages, when an upcoming event is pending. The digital planner has proven to be a highly successful tool for the businessperson and, in most instances, has replaced the need for conventional hard copy or paper daily planers.

Most digital media files can be easily categorized and stored according to a calendar date. For example, a wedding video can be categorized according to the date of the wedding and photographs taken at a party can be categorized according to the date of the party. These are examples of categorizing the media file based on the creation date of the media file. In other instances the media file can be associated with the date on which the media file is used or presented or the date on which the recipient receives the file. For example, a multimedia presentation for a business meeting may be categorized according to the date of the presentation and a personal text file from a friend may be categorized according to the date received.

Over time, digital devices with large memory capacity possess the capability to acquire and store an enormous volume of media files. This is especially true as we enter a burgeoning digital communication era where more and more digital devices will possess the capability to communicate digitally. For example, in a future where more and multi-function digital devices are prevalent, such as mobile telephones with digital cameras and conventional digital cameras, digital video recorders and the like have the capability to communicate digitally, the devices will be inundated with digital media files. The user of these devices, and all other digital devices capable of media storage, will desire an application that stores and manages the digital media files. A key attribute for such an application is user efficiency; because the user must be able to efficiently locate media files.

An additional concern of handheld digital communication devices is that the devices are characteristically small in size to accommodate being held in one's hand. Applications that are implemented in such devices will gain acceptance by device users if the user can navigate them ergonomically. In this regard, applications that either minimize the amount of inputs required of the user or minimize the physical effort or discomfort encountered by the user's hand in making inputs is preferred.

Therefore, the need exists to develop a media file storage and management application for a digital device that will provide for the storage of a large volume of media files and user efficiency in terms of being able to quickly locate a specific media file. The media file storage and management application should be capable of associating and organizing the media files according to a period of time, such as a day, week or the like. As such, the media management application should provide the user with a system for easily navigating through the time periods in order to efficiently locate a media file.

### BRIEF SUMMARY OF THE INVENTION

The present invention provides for a media diary or media management application implemented in a digital device that incorporates a speed browsing mechanism. The speed browsing mechanism provides for the speed of the browsing or scrolling function to be altered depending on the desire of the user. For example, if the media diary currently displays time periods that are distant from the desired time period, the user will desire a rapid browsing function. Conversely, if the media diary currently displays time periods that are close to the desired time period, the user will desire a deliberate browsing function. The speed browser can be configured by the user to browse for time periods, specific types of media files, annotated or bookmarked media files or any other user designated browse-able parameter. The speed browsing mechanism of the present invention provides the device user with a highly efficient means of locating time periods and the media files associated with the time periods. In addition, the speed browsing mechanism provides ergonomic benefit to the user, in that, user inputs to the device are limited and the user inputs that are required are user-friendly.

In one embodiment of the invention an application for representing media files on a digital device includes a computer readable storage medium having computer-readable program instructions embodied in the medium. The computer-readable program instructions will include first instructions for generating a media view that provides access to digital media files and associates digital media files with a predefined time, and second instructions for generating a media handle that provides the ability to browse a view generated by the application over several periods of time. The instructions may also provide for a speed of browsing may be proportional to the distance that the handle is deviated from a centerline position on a digital device display. The second instructions may additionally include instructions for increasing the speed of browsing as the distance from the centerline position is increased and instructions for decreasing the speed of browsing as the distance from the centerline position is decreased. The second instructions may additionally include instructions to browse the media view and calendar view according to a chosen browse parameter. The chosen browse parameter may include time, media file type, metadata information, media file bookmarks, media file representation and the like. Additionally, the second instructions may include instructions for automatically decreasing the speed of the browsing when media files in accord with the chosen browse parameter are in, or enter, a viewable area of the display and increasing the speed of the browsing when media files in accord with the chosen browse parameter are not in, or bypass, the viewable area of the display. Typically, the first instructions for generating a media view will associate media files with a past period of time.

The invention may also be embodied in a digital device including a processing unit that executes computer-readable program instructions for accessing media files. The computer-readable program instructions comprising (1) first instructions for generating a media view that provides access to digital media files and associates digital media files with a predefined time, and (2) second instructions for generating a media handle that provides the ability to browse media view and calendar view over a period of time according to a chosen browse parameter. The second instructions may provide a speed of browsing that is proportional to the distance that the handle is deviated from a centerline position on a digital device display. Additionally, the digital device will include a display in communication with the processing unit that presents a combined view of the media view and the hierarchal time bar.

The invention may also be embodied in a method for browsing media files in a media application. The method includes the steps of providing for a media view and a media handle on a display associated with a device implementing the media application, deviating, the media handle, a distance from a centerline position on the display; and setting the browse speed according to the distance that the media handle deviates from the centerline position in order to locate a desired media file representation within the media view. In addition, the method may include the step of adjusting the deviation distance an appropriate amount and adjusting the browse speed according to the adjusted deviation distance to the desired media file within the media view. The method may also include the step of defining a browse parameter prior to deviating, the media handle, a distance from a centerline position on the display. The browse parameter being any browse-able search parameter, such as time, media file type, metadata information, media file bookmarks, media file representation and the like. Additionally, the method may include the step of automatically altering the browse speed when media files of a type associated with the desired media file are within the media view.

Therefore, the present invention provides for a media file storage and management application for a digital device that will provide for the storage of a large volume of media files and user efficiency in terms of being able to quickly locate a specific media file using the media handle/speed browser mechanism herein disclosed. The media file storage and management application is capable of associating and organizing the media files according to a period of time, such as a day, week or the like. As such, the media management application and, more specifically, the unique speed browser provides the user with a system for easily navigating through the time periods in order to efficiently locate a media file.

### BRIEF DESCRIPTION OF THE DRAWINGS

Having thus described the invention in general terms, reference will now be made to the accompanying drawings, which are not necessarily drawn to scale, and wherein:

FIG. 1 is an illustration of a timeline view in combination with a calendar view and media view that incorporates a media handle/speed browser, in accordance with an embodiment of the present invention FIG. 2 is an illustration of a calendar view or calendar window as displayed by the media diary.

FIG. 3 is an illustration of media view or media window as displayed by the media diary.

FIG. 4 is an illustration of a media view that incorporates a media handle/speed browser and a center line, in accordance with an embodiment of the present invention.

FIG. 5 is an illustration of a media view that incorporates a media handle/speed browser, in accordance with an embodiment of the present invention.

FIG. 6 is a block diagram of a digital device implementing a media diary that incorporates the use of a media handle/speed browser, in accordance with an embodiment of the present invention.

FIG. 7 is a flow diagram of a method for browsing media files in a media diary application, in accordance with an embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention provides for a media diary or media management application implemented in a digital device that incorporates a speed browsing mechanism. The browsing mechanism provides for the speed of the browsing or scrolling function to be altered. In a manual mode the user will dictate the browse speed and in automatic mode the media diary application will dictate the browse speed. For example, in the manual mode, if the media diary currently displays time periods that are distant from the desired time period, the user will desire a rapid browsing function. Conversely, if the media diary currently displays time periods that are close to the desired time period, the user will desire a deliberate browsing function. The automatic mode is typically implemented in conjunction with a search function and provides for search results to be presented by automatically speed browsing to the area of the media view where the searched files reside.

The browsing mechanism of the present invention, referred to herein as speed browsing, provides the device user with a highly efficient means of locating time periods and the media files associated with the time periods. In addition, the speed browsing mechanism provides ergonomic benefit to the user, in that, user inputs to the device may be limited and the user inputs that are required are user-friendly.

The media diary application of the present invention will associate media files with a predefined time, typically a moment of time or a period of time, or an event, so that the user can manage media files according to a moment of time, period of time or an event. Typically, the period of time will be a specific date associated with a date that the media file was created or intended for. For example, if the media file is an image or video file of a birthday party, the media application may categorize and store the file according to the date of the birthday party. For a complete description of the media diary application see co-pending U. S. patent application Ser. No. ______, entitled, “Media Diary Application for use with Digital Device”, filed on Nov. 17, 2003, in the name of inventor Myka et al., and assigned to the same assignee as the present invention. That application is herein incorporated by reference as if set forth fully herein.

The media diary application may take the displayed form of a media view and calendar view combined with a timeline view or a media view in combination with the timeline view. In both embodiments of the media diary application the timeline view may incorporate the speed browser of the present invention.

The media diary application of the present invention may be implemented and executed on any electronic device that incorporates a display, such as a desktop or portable computer, cellular telephone, personal data assistant (PDA), digital camera, digital camcorder, e-book device, television, digital audio player or the like. In addition the media diary application may be implemented on electronic devices that are connected to an external display, such as a set-top box (STB), personal video recorder (PVR), digital video recorder (DVR) or the like. While in most implementations the digital device that executes the media diary application will be capable of any type of wireless or wireline network communication, such as wireless telecom, short range radio network, Bluetooth®, Wireless Local Area Network (WLAN), Radio Frequency Identification (RFID), Internet Protocol Data Casting (IPDC), Digital Video Broadcasting (DVB), Infrared Data Association (IrDa), Internet or the like, it is not required that the digital device be adapted to communicate via network. Devices that are capable of requiring digital media files internally or may access media files through memory devices (e.g., flash storage device, memory sticks, video and audio storage tapes, CD, DVD, removable hard disc device (HDD) and the like) are also applicable.

In accordance with an embodiment of the present invention, the media diary application will be embodied by a computer-readable storage medium having computer-readable program instructions stored in the medium. The storage medium will typically be a memory device, such as flash ROM memory, HDD or the like. The programming instructions may be written in a standard computer programming language, such as C++, Java or the like. Upon execution by a processing unit as described below, the program instructions will implement the various functions of the media diary application as described below. The computer-readable program instructions include first instructions that will generate a media view that provides access to digital media files and associates digital media files with a moment of time, period of time or event. The computer-readable program instructions will include second instructions that generate a speed browser that provides for the periods of time in the media view to be efficiently accessed. In another embodiment, the computer-readable program instructions include third instructions that will generate a calendar view that represents time in calendar format and associates events with respective time information, such as moment or periods of time. While the first, second and third instructions may be modules, objects or the like that communicate with one another, the first, second and third instructions need not be discrete or separable portions of the program instructions and may be interspersed throughout if so desired.

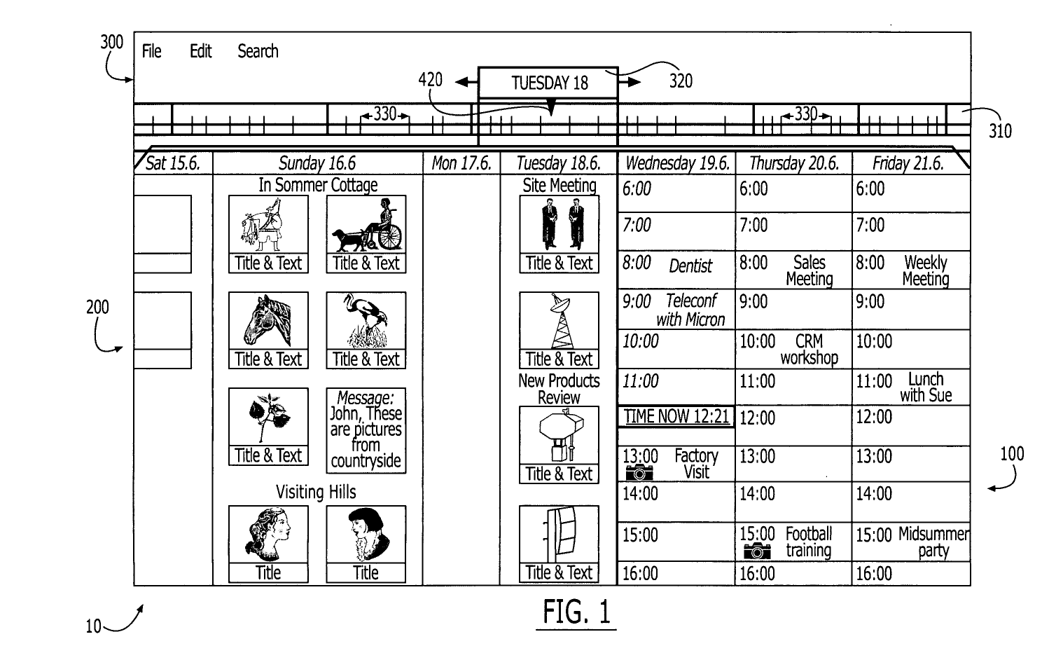

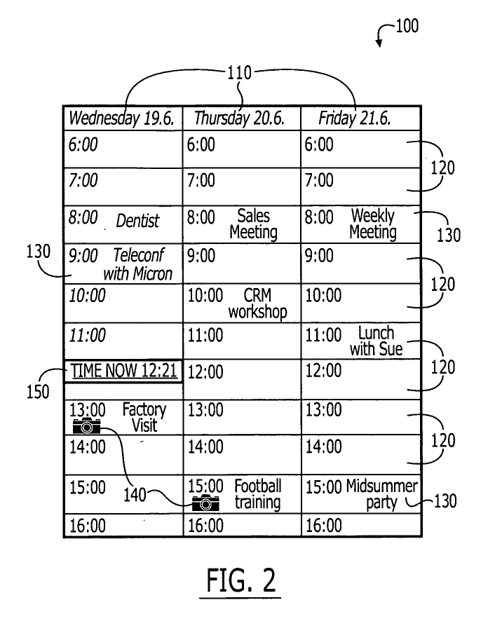

FIG. 1 illustrates an example of a media diary application display 10 that provides a calendar view 100, a media view 200 and a timeline view 300 with a media handle/speed browser 320, in accordance with an embodiment of the present invention. The timeline view will incorporate a speed browser that takes the form of a media handle that can be moved from left to right or the display to adjust the scrolling speed. In accordance with embodiments of the present invention, a more detailed description of the speed browser, its functionality and methods for use will be provided for later in the detailed description.

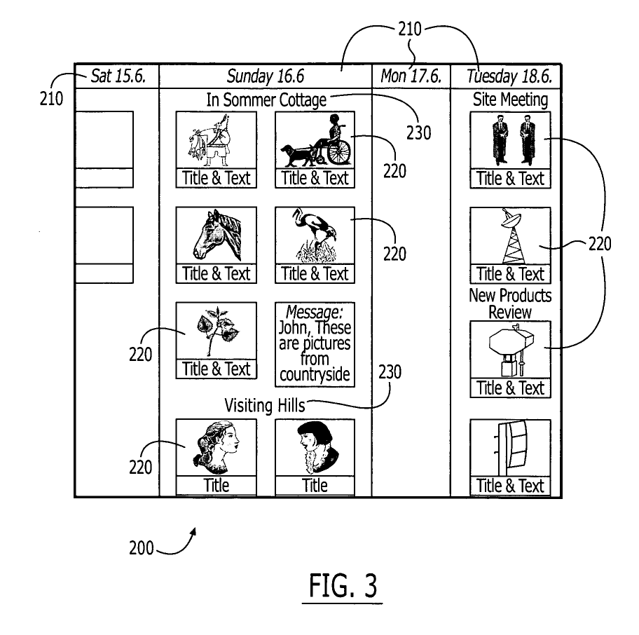

In order to better understand the media diary application display 10 of FIG. 1, isolated representations of an exemplary calendar view and media view are presented in FIGS. 2 and 3.

FIG. 2 illustrates an example of a calendar view 100 that provides for the entry of calendar events and provides the user with a daily planner application. The calendar view may be displayed in conjunction with the media view and the time line view to present the media handle/speed browser, in accordance with an embodiment of the present invention. The calendar view may be generated by computer-readable program instructions implemented in association with a digital device. It is noted that the calendar view herein depicted and described is by way of example only; other calendar views that provide for the display of calendar events or reminders are also contemplated and within the inventive concepts herein disclosed. While the calendar view is typically associated with future time periods, future events and future reminders, it may also possible for the calendar view to display past time periods, past events and past reminders. Alternatively, the calendar view may be generated by another calendar or personal planner application, in which case, the calendar view is imported into the media diary application from the auxiliary calendar application.

The calendar view includes date columns 110, which correspond to a specific date. In the example shown, three date columns are visible on the display corresponding to the current date (i.e., Wednesday, 19 June) and the subsequent two dates. Typically, upon activation of the calendar view the current date will be displayed in the left-hand column of the calendar view with columns for the subsequent dates positioned sequentially to the right. As will be apparent, the calendar view may be differently oriented, such as with rows as opposed to columns or the current date may be displayed in the right hand column, if so desired. In an alternate embodiment the calendar view may include columns 110, which may correspond to any moment of time, such as year, month, day, hour or the like. Additionally upon activation of the calendar view the current moment of time may be displayed on the middle of the view.

The date columns 110 include multiple time blocks 120, which provide a descriptive area for information related to calendar events 130. In the embodiment shown, the time blocks correspond to one-hour time blocks, although the blocks may be for other lengths of time, such as 30-minute blocks. Further, for example if a column represents a year, the time block 120 may represent a month. The calendar view will be vertically scrollable, so that, all of the time blocks for a date column will be viewable by the user. In addition, the calendar view will typically be horizontally scrollable to provide for a view of other date or time columns 110. In addition, the time blocks may include reminder icons 140, which provide the media diary user a visual reminder related to an upcoming calendar event. For example in the depicted embodiment, the camera icon reminds the user that calendared event requires or will benefit from a having a camera on-hand.

The information related to calendar events 130 will typically be inputted by the user and include information, such as title of the event, topic of the event, date and time of the event, location of the event, individuals attending the event and the like. A calendar event may be inputted by activating, via keystroke or mouse-type input signal, the time block associated with the event. Upon activation, a window or view is made visible that allows for the user to input information related to the event. Once the calendar event has been inputted and text displayed in the time block, the details of the calendar events may be accessible by activating, via keystroke or mouse-type input signal, the calendar event. In addition to manually inputting calendar events, the media diary may import calendar events from other sources or applications that are being executed on the digital device, such as from other, internal or external, personal planner or calendar applications, email systems or the like. Further, the information related to a calendar event 130 creates metadata information related to the calendar event or reminder.

The time blocks 120 may include a time now indicator 150 that may be accentuated in bold-faced type or other way graphically accentuated in the time block that includes the current time. The time now indicator serves to indicate the current moment of time. The time now indicator will be an active indicator that displays the current time, in hour and minutes, and moves forward to the next time block with the passage of time. In addition, the calendar view 100 may graphically distinguish between time blocks and calendar events that are in the past and time blocks and calendar events that are in the future. In the illustrated example, time blocks and events in the past are designated by italicized text and time blocks and events in the future are designated by non-italicized, standard text. As the time now indicator moves to the next time block to indicate the passage of time, the distinguishing graphics of the time blocks and calendar events will also change to indicate the proper time state.

FIG. 3 illustrates an example of a media view 200 that provides for digital media files, such as digital images, digital video, digital audio, computer games, computer software, digital text files or the like, to be accessible to the media diary user, in accordance with an embodiment of the present invention. Typically the media files that are represented in the media view will be associated to a past calendar event or past reminder. The media view will be generated by second computer-readable program instructions implemented in association with a digital device. It is noted that the media view herein depicted and described is by way of example only; other media views that provide for the display of media file representations in association with a moment of time or a time period are also contemplated and within the inventive concepts herein disclosed. Alternatively, the media files that are represented in the media view may be associated with a moment or period of time based on a timestamp in the media file, without having noted an event related to the media file, in advance, in the calendar view or application.

The media view of the illustrated embodiment includes date columns 210, which correspond to a specific date, although the media view may be differently oriented if so desired. In the example shown, four date columns are visible on the display corresponding to the four previous dates. In an alternate embodiment the media view may include columns 210, which may correspond to any moment of time, such as a year, a month, a week, a day, an hour or the like. The date columns will include media file representations 220 that are related to media files and are connected, in time, to the specific date, event and/or time. For example, the media file representations may include representations that provide the user with access to digital files, such as video files, image files, audio files, text files, emails, short message service (SMS) messages, multimedia message service (MMS) messages and the like and provide the user with information pertaining to the content of the files. The media file representations may include an icon, or a thumbnail image, a portion of the text of a text document or message or any other suitable media file representation with or without a title of the media file.

Typically, the media diary will receive the media file from a digital recording function associated with the device or via digital communication from other devices. For example:
1) If the digital device is a cellular telephone that incorporates a digital camera or any other digital device that serves as a digital recording device, a digital media file (i.e., image) may be communicated directly via cellular telephone access from the camera/telephone device to the media diary in another device.
2) If the digital device is an independent digital camera or any other digital recording/storing/playing device and equipped with a wireless or wireline network connection the digital media file may be communicated directly from networked device to a media diary in another device.
3) If the digital device is an independent digital camera or any other digital recording/storing/playing device and equipped with short range digital communication means the digital media file may communicated first to a long range digital communication device (i.e. cellular telephone, a PDA, laptop or the like) that then passes the files to another device with a media diary. Alternatively, in proximity, a file transfer may occur directly to another device with a media diary.
4) The media files may be communicated by a physical memory unit/device transferred from one device to another device.

As such, the digital recording/storing/playing device from which the media file is communicated (i.e., the passing device) may include, and implement, the media diary application or may not include the media diary application. If the passing device includes the media diary application, the media files may be processed for media diary purposes prior to communication to other devices.

The communication/synchronization of the media files may be automatic after a creation of a new media file, or after a certain amount of media files have been created. Alternatively, the communication may occur at a selected time or on a request of a user and may include a single media file or a group of media files. The communication/synchronization may occur via any wireless or wireline network communication method, such as for example via SMS, MMS or file transfer. The communication, i.e. synchronization, may also occur from a back end media diary application/device to any digital recording/storing/playing device with or without the media diary application.

The media file will typically have associated metadata, in the form of a timestamp, event name, file name, location information, people in the event or in the media file, objects in the media file, file type, file size or the like. The media file metadata may be automatically inputted by the digital recording device at the time of the creation of the media file or may be manually inputted, such as at the time of creation of the media file or receipt or transfer of the media file. In addition, it is possible for the metadata to previously exist in conjunction with a calendar event in the media diary and to be associated with the digital media file at the moment the file is created, if the device creating the media file executes the media diary application.

Once the media diary receives the media file, the media file metadata is combined and/or correlated with the calendar event information. The combined and/or correlated information is associated with the media file in the media view, such that, when a user accesses the media file via the media file representation the user will be presented with the combined metadata and calendar event information. See for example, media file representations 220 of FIG. 3, in which, a thumbnail image is combined with a title and text entry.

Referring again to FIG. 1, which depicts media application display 10 that is a combination of a calendar view 100, a media view 200 and a timeline view 300. The timeline portion of the view incorporates a speed browser, in accordance with an embodiment of the present invention. As depicted, the calendar view 100 is displayed on the right-hand side of the digital device's display, the media view 200 is displayed on the left-hand side of the display and the timeline view features are displayed above both the calendar view and the media view. The timeline view and, specifically, the speed browser will be generated by the computer-readable program instructions as implemented in association with a digital device. It is noted that the timeline view and, specifically, the speed browser herein depicted and described is by way of example only; other configurations of timeline views and speed browser that provide for the display of a timeline and speed browsing function in combination with a media view and a calendar view are also contemplated and within the inventive concepts herein disclosed.

The timeline view 300 of the illustrated embodiment provides for a time bar 310 and a media handle/speed browser 320, also referred to as a time handle. The media handle/speed browser provides for the speed browsing function of the present invention. As depicted, the calendar view 100 displays the current date, indicated by a current time indicator 150, and the two subsequent dates. The media view 200 displays the four previous dates.

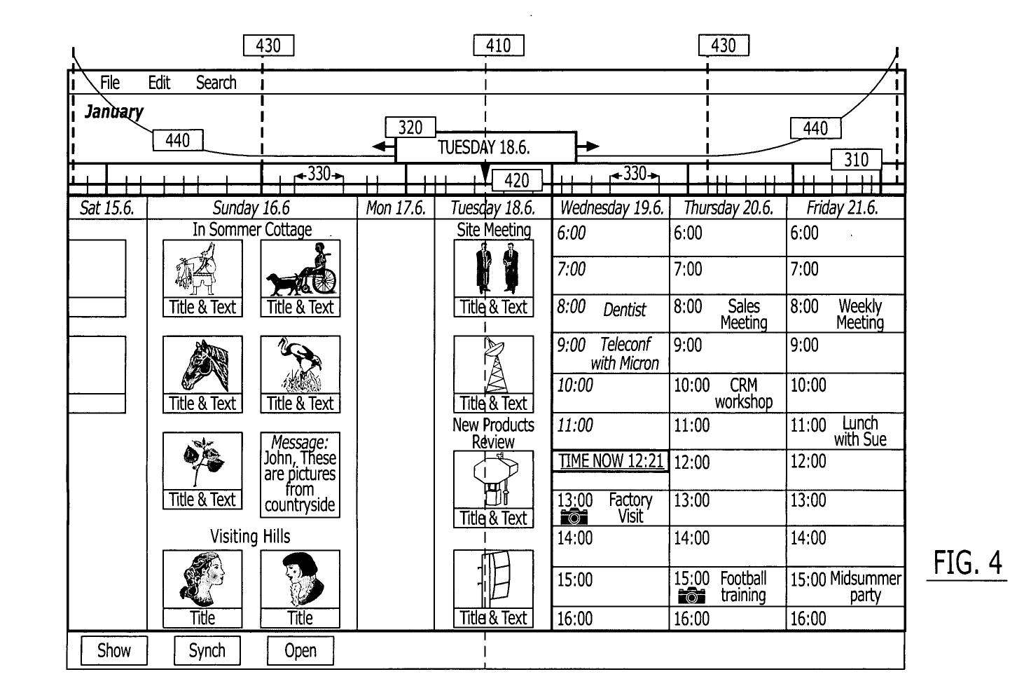

The media handle/speed browser 320 depicted in FIGS. 1 and 4 is shown in a stationary rest position, preferably in a centerline position, e.g. in FIG. 1 related to a time bar, or related to display of the media diary application and in FIG. 4 related to a media view. In the centerline position the media handle/speed browser is associated with an underlying column of the media view and the media handle/speed browser will display the date associated with the underlying column. Additionally, in the centerline position the media handle/speed browser will typically be associated with an underlying time unit, such as a day, of the time bar. The media handle/speed browser will display the time unit, such as the date, associated with the underlying time unit in the media handle.

The media handle/speed browser 320 will typically have a center mark 322 for indicating a center point of the media handle/speed browser. When the media handle is in a rest position, typically a centerline position, the center mark will point to an associated time unit 330 within the time bar 310. This associated time unit will be indicated on the media handle and either the media view or the calendar view associated with the time unit will generally underlie the center mark. When the media handle is in a deviated position, the center mark will point to an associated time unit within the time bar and the media view or calendar view associated with that time unit will be presently scrolling in the viewable display.

In addition, in the rest position, the length of the media handle 320 will overlie the time units 330 in the time bar 310 that are currently being displayed in the media view 200 and/or calendar view 100. In the illustrated example of FIG. 1, the length of the media handle overlies at least a portion of seven time units, these seven times units correspond to the 7 days in the media and calendar views; 4 days in the media view (15 June-18 June) and 3 days in the calendar view (19 June-21 June). In this regard, media handle will automatically deviate in length to accommodate the amount of time units that are currently within the viewable area of the display. Areas of the time bar that do not underlie the media handle provide the user with a visible indication of media file content in time periods outside of those displayed in the viewing area.

In the manual mode movement of the media handle/speed browser is typically accomplished by keystroke or mouse-type activation. Typically a click and drag function of a mouse type interface is used to move the media handle/speed browser to the left or to the right. For example, if the user moves the media handle/speed browser to the left, the calendar view and media view will scroll to the right, such that, more past dates in the media view will be displayed. If the user moves the media handle/speed browser to the right, the calendar view and media view will scroll to the left; such that, more future dates in the calendar view will be displayed.

The media handle/speed browser may also be deviated automatically to locate a specific moment of time, period of time or event. The automatic mode is typically implemented in conjunction with a search function and provides for search results to be presented by automatically browsing to the area of the media view where the searched files reside.

If the media handle/speed browser 320 is deviated a relatively short distance from the center position, deliberate speed browsing will occur. In this instance, the time bar, the media view and/or the calendar view will move relatively slowly in the opposite direction of the deviation and the corresponding dates and media file representations will appear in the display area. If the media handle/speed browser is deviated a relatively long distance from the center position, fast speed browsing will occur. An example of a relatively long distance would be deviating the media handle to a position adjacent to a horizontal end of the display. In this instance, the time bar, the media view and/or calendar view will move relatively fast in the opposite direction of the deviation and the corresponding dates and media file representations will appear in the display area. Once the media handle/speed browser is released from the deviated position, the media handle/speed browser will stop speed browsing and return, automatically, to the rest position, such as the centerline position. Once the media handle/speed browser returns to the centerline position, the media handle/speed browser will indicate the date at the moment the media handle/speed browser was released from the deviated position and the media view column, calendar view column or time bar unit associated with the moment of time, such as the date, will underlie the center positioned media handle/speed browser.

For example, if the user of the media diary 10 wishes to access a date in the near past, the user will deviate the media handle/speed browser 320 a relatively short distance, e.g. to the left. Moving and holding the media handle a short distance to the left, will invoke deliberate speed browsing of the past dates. When the desired date is evident on the media handle/speed browser, the user may release the media handle/speed browser. Release of the media handle/speed browser will automatically reposition the media handle/speed browser in the centerline position and the desired date and associated media view or calendar view will underlie the media handle/speed browser.

Alternately, if the user of the media diary wishes to access a date in the distant past, the user will deviate the media handle, e.g. to the far left of the display (i.e., adjacent to the left side of the display), preferably along the time bar. Moving the media handle to the far left of the display, will invoke fast speed browsing of the dates. This entails hastily ramping up the browse function from a slow browsing speed to a fast browsing speed. When the user is in the near vicinity of the date they wish to access, the media handle can be released to move the time bar back to the centerline position. Releasing the media handle to reposition the media handle in the centerline position also repositions the time bar, the media view and the calendar view, accordingly. This will allow the user to focus in on the desired date by deviating the media handle a relatively short distance from the centerline. Alternatively, when the media bar is positioned to the far left of the display and the speed browsing function has moved into the vicinity of the desired date, the media handle/speed browser can be moved to the right to slow down the speed browsing function. Slowing down the speed browsing function will allow the user to focus in on the desired date and smoothly center the desired content in the media view.

Additionally, when the media handle/speed browser is deviated to a position that invokes fast speed browsing, the browsing function may be configured to slow down for those specific dates that have media files associated with them. Slowing down the speed browse function to a monitoring speed will allow the user to view the media file representations in the media view or the calendar events in the calendar view to determine if the media file or calendar event is the specific one which the user wishes to access.

FIG. 4 provides an illustrative example of how the speed browsing function of the media handle is implemented, in accordance with an embodiment of the present invention. The media handle 320 is initially in a stationary position, as depicted the stationary position centers the media handle with the center line 410. As such, in the depicted stationary position the center mark 420 of the media handle resides on the center line. When the media handle is deviated from the stationary position (i.e., move left or right from the center line) the view of the media diary application will scroll in the direction opposite of the direction of the deviation. Thus, as depicted, deviation of the media handle to the right, will scroll more of the calendar view into the viewable area of the display and deviation of the media handle to the left, will scroll more of the media view, and associated media file representations, into the viewable area of the display.

When the media handle 320 is deviated a predefined “short” distance the scrolling that results is deliberate step-wise scrolling in accordance with the time units 330 in the underlying time bar 310. In the illustrated example the predefined “short” distance is defined as the distance between imaginary marks 430. As long as the media handle is deviated between marks 430, the step-wise scrolling is limited to the underlying media or calendar view (i.e., the time bar remains stationary). Thus, as the media handle is moved, the center mark 420 will point to the time unit that will move to the centerline in the absence of further movement of the time handle. For example, if the time units 330 in the illustrated example are days, as the media handle is moved, once the center mark encounters the time unit on the time bar, the date associated with the time unit will be displayed in the media handle, the date will be scrolled into the media view or calendar view, and associated media file representations or calendar event reminders will be visible on the display proximate the centerline 410.

Once the center mark 420 of the media handle 320 is deviated beyond the predefined “short” distance (i.e., mark 430), the time bar will scroll simultaneous with scrolling of the underlying media view or calendar view. When the extent of the deviation is further increased beyond mark 430 the scrolling speed will increase, such as in a linear fashion or an exponential fashion, as indicated by the speed line 440, this is referred to as accelerated or speed browsing. The speed line is shown for illustrative purposes only and does not actually appear in the timeline view of the media diary application. In the accelerated browsing mode, the media handle may be held in a stationary position to provide for accelerated browsing through periods of time. Additionally, in the accelerated browsing mode the center mark of the media handle will point to a time unit in the scrolling time bar, the time unit will be rapidly be displayed in the media handle and the media view and/calendar view will be rapidly scrolled. Once the deviated media handle is released, it returns, automatically, to a rest position, typically the centerline 410 position. The time unit that the center mark points to, as well as, the media handle become centered in the display.

In accordance with alternate embodiments of the present invention, the user may configure the speed browser such that parameters other than time are browsed. For example, the speed browser may be configured to browse (1) certain types of media files (i.e., video, audio, etc), (2) media files designated with a specific bookmark, (3) media file representations that are enlarged or framed, (4) specific annotated dates or time periods, (5) specific dates with greater than a specified number of media files, (6) or any other item of metadata associated with the media file in addition to those mentioned above, or any other suitable parameter can be defined for the purpose of browsing in any combination of the above. In this instance, the media diary may be configured with a speed browser search function and/or a menu for selecting the speed browser parameter of interest.

For example, if the speed browser is configured by the user to browse for video files, the browser will move to those areas within the media view that include video files and other dates that do not include video files will be moved over in the browsing function. In this example, if the media handle is deviated to provide for fast speed browsing, the browse function may include a slow down speed to a monitoring speed when a media view displays video files, to allow the user to assess their desire to access the represented video files. After a duration of browsing in the monitoring speed, long enough to allow the user to assess the displayed video file representations, the speed browser will again accelerate to a fast browse mode until the next media view having video files is encountered and browsing is once again slowed down.

Alternatively, if the speed browser is configured to search for a specific media file, the browser may be configured to speed browse to the desired media file and to immediately discontinue the browse function once the media file has been browsed into the display area. The browsing will start again by deviating or clicking the media handle again, e.g. by a mouse-type activation or keystroke.

In another embodiment, if the speed browser is configured by the user to browse any combination of items of metadata in a media file, such as e.g. for video files, when the media handle is deviated or clicked by a mouse cursor the browser will immediate move or step to the first area, such as a day, within media view that includes video files and other dates that do not include video files will be skipped over. When the media handle is deviated or clicked by a mouse cursor again the browser will immediate move or step to the next area within media view that includes video files and other dates that do not include video files will be skipped over. In this example, the browser is to provide for fast browsing by skipping, automatically dates that do not include the determined combination of items of metadata, such as video files.

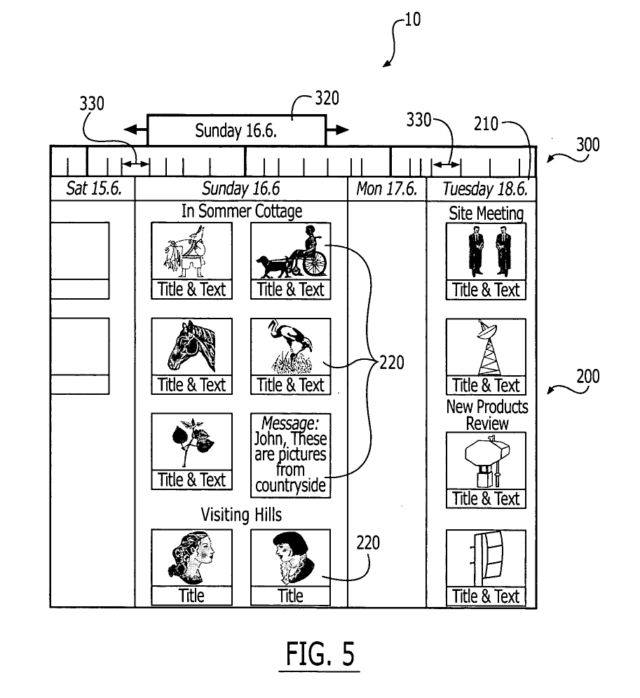

FIG. 5 illustrates an alternate embodiment of the present invention, in which, the media diary display includes a combination of a media view 200 and a media handle/speed browser 320. In this embodiment, the computer-readable program instructions will generate a media view that provides access to digital media files and associates digital media files with a period of time. The instructions will additionally generate a media handle/speed browser. The media view includes date columns 210, which correspond to a specific date. In the example shown, four date columns are visible on the display corresponding to four dates. The date columns will include media file representations 220 that are related to media files and are connected, in time, to the specific date and may further be connected within a date to a specific topic. For example, the media file representations may include representations that provide the user with access to digital files, such as video files, image files, audio files text files and the like and provide the user with information pertaining to the content of the files. The media file representations may include an image and title of a digital image or video file, a portion of the text of a text message or any other suitable media file representation.

In this embodiment of the invention, the date columns may include both past dates, present dates and future dates. While most media files will be categorized in past date columns it is possible for media events to be categorized in future date columns. For example, a yet-to-be presented multi-media presentation can be categorized under a future date column.

The features of the timeline view 300 will include a media handle/speed browser 320. The media handle/speed browser will typically be visible in the timeline view and be centered in the visible display in a stationary position. In the same manner as described above, the media handle/speed browser can be moved to the left or right on the display to provide for browsing of the dates within the media view. The media handle/speed browser of the FIG. 5 embodiment will have all the configuration and functionality possibilities that have been described above in relation to FIGS. 3 and 4.

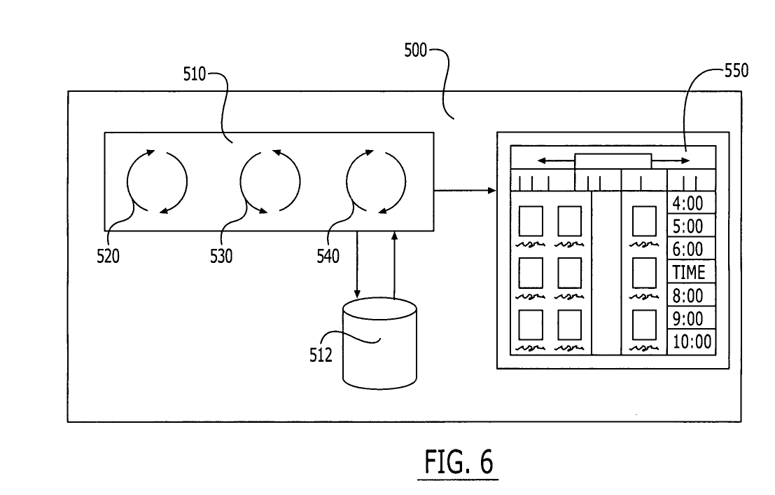

A further embodiment of the invention is defined by a digital device that implements the media diary application and specifically the speed browser aspect of the media diary, in accordance with an embodiment of the present invention. FIG. 6 illustrates a block diagram of digital device 500 that implements the media diary. As previously noted, the digital device may be a digital device capable of digital communication by any means of network or by portable memory unit with other digital devices, such as a mobile terminal including for example, a mobile telephone, a PDA, laptop computer, a digital camera, a digital video camera, electronic book device, digital audio recorder, personal computer, set-top box (STB), television or the like.

The digital device 500 will include a processing unit 510, such as a processor, an application specific integrated circuit, analog and/or digital circuitry, or any other similar device that executes computer-readable program instructions for accessing media files. Wherein the program instructions and the media files are generally stored in memory device 512. The computer-readable program instructions may include first instructions 520 for generating a media view that provides access to digital media files and associates digital media files with a period of time, and second instructions 530 for generating a calendar view that represents time in calendar format and associates events with respective periods of time and third instructions 540 for generating a speed browser that provides for the user to alter the speed of browsing function to efficiently locate media files within the media diary. In an alternate embodiment, the operating instructions may be limited to first instructions 520 for generating a media view that provides access to digital media files and associates digital media files with a period of time and second instructions 540 for generating a speed browser that provides for the user to alter the speed of browsing function to efficiently locate media files within the media diary. In addition, the digital device will include a display 550 that is in communication with the processing unit and provides a presentation mechanism for the calendar view and the media view.

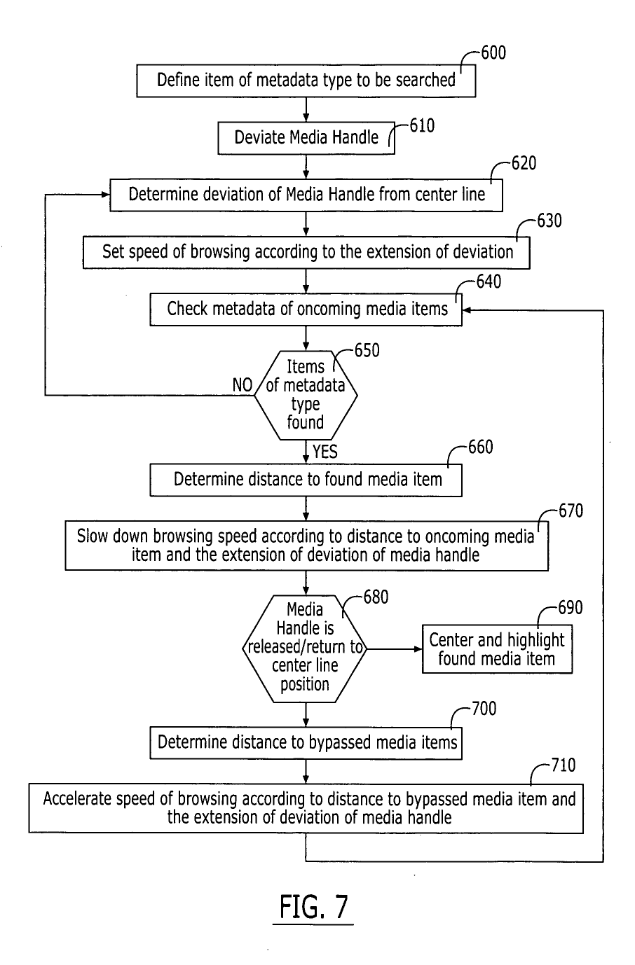

Additionally the invention is embodied in a method for automated browsing of media files in a media diary. Referring to the flow diagram of FIG. 7, at step 600, the user defines an item of metadata information that is to be browsed. Metadata is information, such as file type, file title, date file was created, file creator, etc., which is stored in association with the media file. For example, a user may choose to browse for all video files or the user may choose to browse for a particular media file having a specified title. Defining the browse criteria may involve a keyword search of the browse term or the browse criteria may be chosen from a menu of browse-able metadata items.

At step 610, the browse function is initiated by deviating the media handle from the rest position, preferably the stationary centerline position on the digital device display. At stage 620, the media diary determines an approximate length of deviation from the centerline necessary to locate the media file(s) that are being browsed and the media handle is automatically deviated the determined length. At step 630, the browse function speed is set according to the amount that the media handle deviates from the centerline position. If the media handle deviates a relatively small degree from the centerline position the rate of browsing will be relatively slow and if the media handle deviates a relatively large degree from the centerline position the rate of browsing will be relatively fast. At step 640, the system observes the media file representations and accompanying metadata information associated with media files as they are scrolled across the display to determine if one of the scrolled media files is the desired media file. Alternatively, the system observes metadata of the media files that are approaching the visible display area already before they enter the visible display area (in order to create smooth slow down of the scrolling). The distance of the observing, approaching media files may vary according to the speed of the browsing, i.e., greater distance when the browsing speed is high and vice versa, or it may be a constant.

At step 650, the system determines if the media file and accompanying metadata information have been found. If they have not been found then the process returns to step 620, where the system determines a deviation distance and further browsing occurs, iteratively, until the defined media file is found by the system. If the media has been found then, at step 660, the system may estimate the distance remaining to be scrolled to bring the media file into the viewable area of the display. At step 670, the system may slow down the browse speed by a predetermined manner, e.g. according to the distance to the approaching found media file and the extension of the deviation of the media handle from the centerline on the media view (or the display), in order to bring the media file within the viewable area of the display, thereby smoothly slowing the speed of browsing even though the user does not move the media handle. At step 680, the media handle is released by the media diary application and the media handle returns to the centerline position.

After releasing the media handle, at step 690, the found media file, the relevant time unit (such as a date column) and the time bar are centered in the media view (or in the display) at the same time. If the desired media file has bypassed the centerline on the media view (or the display), at step 700, the system then determines the distance to the bypassing media file and, at step 710, accelerates the browsing speed by a predetermined manner, e.g. according to the distance to the bypassed media file and the extension of the deviation of the media handle from the centerline on the media view (or the display). The system will return to step 640 to observe the metadata of approaching media files and ascertain whether the approaching media files meet the browse criteria. The process continues, iteratively, until the system locates and displays all of desired media files that meet the browse criteria. Alternatively, when the desired media file has bypassed a visible area of the viewable display, at step 700, the system than determines the distance to the bypassed media file and, at step 710, accelerates the browsing speed by a predetermined rate.

The described embodiments of the present invention provide for a media diary or media management application implemented in a digital device that incorporates a speed browsing mechanism. The speed browsing mechanism provides for the speed of the browsing or scrolling function to be altered depending on the desire of the user. For example, if the media diary currently displays time periods that are distant from the desired time period, the user will desire a rapid browsing function. Conversely, if the media diary currently displays time periods that are close to the desired time period, the user will desire a deliberate browsing function. The speed browsing mechanism of the present invention provides the device user with a highly efficient means of locating time periods and the media files associated with the time periods. In addition, the speed browsing mechanism provides ergonomic benefit to the user, in that, user inputs to the device are limited and the user inputs that are required are user-friendly.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An application for providing access to media files on a digital device, the application comprising a computer readable storage medium having computer-readable program instructions embodied in the medium, the computer-readable program instructions comprising:
first instructions for generating a media view that provides access to digital media files and associates digital media files with a period of time; and
second instructions for generating a media handle that provides the ability to browse a view generated by the application over several periods of time.

2. The application of claim 1, wherein the second instructions for generating a media handle further provides the ability to browse periods of time within a view of the application according to a chosen browse parameter.

3. The application of claim 2, wherein the second instructions for generating a media handle provides for the ability to browse periods of time within a view of the application according to a browse parameter chosen from any combination of items of metadata associated with the media files.

4. The application of claim 2, wherein the second instructions for generating a media handle provides for the ability to browse periods of time within a view of the application according to a browse parameter chosen from one or more items of metadata associated with periods of time.

5. The application of claim 3, wherein the item of metadata is chosen from the group consisting of time, media file type, media file size, media file bookmark, media file annotation, media file representation, media file title, media file name, topic, content, location, situation, preferences, contact information, names of people, names of electronic devices, technical information of electronic devices, items described in the media file and tables of content information.

6. The application of claim 2, wherein the second instructions for generating a media handle further includes instructions for decreasing the speed of the browsing when the application determines that an approaching media file is in accord with the chosen browse parameter.

7. The application of claim 6, wherein the second instructions for generating a media handle further includes instructions for decreasing the speed of the browsing in relation to the distance of the approaching media file and extent of a deviation of the media handle from the centerline position.

8. The application of claim 2, wherein the second instructions for generating a media handle further includes instructions for increasing the speed of the browsing when a media file, in accord with the chosen browse parameter, bypasses a centerline of a view generated by the application.

9. The application of claim 8, wherein the second instructions for generating a media handle further includes instructions for increasing the speed of the browsing in relation to the distance of the bypassing media file and extent of a deviation of the media handle from the centerline position.

10. The application of claim 1, wherein the first instructions associate digital media files with a period of time based upon information associated with the digital media file.

11. The application of claim 1, further comprising third instructions for generating a calendar view that represents time in calendar format and associates events with respective periods of time.

12. The application of claim 11, wherein the first instructions for generating a media view that provides access to digital media files and associates digital media files with a period of time, associates digital media files with a past period of time and wherein the third instructions for generating a calendar view that represents time in calendar format and associates events with respective periods of time, associates events with respective future periods of time.

13. The application of claim 2, wherein the second instructions for generating a media handle that provides the ability to browse periods of time within a view of the application according to a chosen browse parameter further includes instructions for browsing the media items by stepping directly to the period of time including the media file having the chosen browse parameter.

14. The application of claim 2, wherein the second instructions for generating a media handle that provides the ability to browse periods of time within a view of the application according to a chosen browse parameter further includes instructions to browse a media view, a calendar view and a time bar.

15. The application of claim 1, wherein the second instructions for generating a media handle further provides for a browsing step function that is proportional to a movement of the media handle along a time bar.

16. The application of claim 1, wherein the second instructions for generating a media handle further provides for generating a center mark on the media handle that indicates the period of time that is browsed to a centerline of the view of the application.

17. The application of claim 1, wherein the second instructions for generating a media handle further provides for a speed of browsing that is proportional to the distance that the media handle is deviated from a centerline position on a view of the application.

18. The application of claims 17, wherein the second instructions for generating a media handle further provides for a speed of browsing that accelerates when the media handle is deviated a certain distance from the centerline position on the view of the application.

19. The application of claim 17, wherein the second instructions for generating a media handle further includes instructions for increasing the speed of browsing as the distance from the centerline position is increased.

20. The application of claim 17, wherein the second instructions for generating a media handle further includes instructions for decreasing the speed of browsing as the distance from the centerline position is decreased.

21. The application of claim 18, wherein the third instructions for generating a media handle further includes instructions for decreasing the speed of the browsing when a media file in accord with the chosen browse parameter enters a viewable area of the display and increasing the speed of the browsing when the media file in accord with the chosen browse parameter bypasses the viewable area of the display.

22. A digital device, the device comprising:
a processing unit that executes computer-readable program instructions for accessing media files, the computer-readable program instructions comprising:
first instructions for generating a media view that provides access to digital media files and associates digital media files with a period of time, and
second instructions for generating a media handle that provides the ability to browse a view generated by the application over several periods of time; and
a display in communication with the processing unit that presents a combined view of the media view and the media handle.

23. The digital device of claim 22, wherein the processing unit that executes computer-readable program instructions for accessing media files, the computer-readable program instructions comprising further comprises a third instructions for generating a calendar view that represents time in calendar format, associates events with respective periods of time and is presented by the display in combination with the media view and media handle.

24. A method for browsing media files in a media application, the method comprising the steps of:
providing for a media view and a media handle on a display associated with a device implementing the media application;
deviating, the media handle, a distance from a centerline position on the display; and
setting the browse speed according to the distance that the media handle deviates from the centerline position in order to locate a desired media file representation within the media view.

25. The method of claim 24, further comprising the step of adjusting the deviation distance an appropriate amount and adjusting the browse speed according to the adjusted deviation distance to locate the desired media file within the media view.

26. The method of claim 24, further comprising the step of defining a browse parameter prior to deviating, the media handle, a distance from a centerline position on the display.

27. The method of claim 26, wherein the step of defining a browse parameter prior to deviating, the media handle, a distance from a centerline position on the display further comprises defining a browse parameter chosen from the group consisting of time, media file type, metadata information, media file bookmarks, and media file representation.

28. The method of claim 27, further comprising altering, automatically, the browse speed when media files of a type associated with the desired media file are within the media view.

29. The method of claim 28, wherein the step of automatically altering the browse speed when media files of a type associated with the desired media file are within the media view further comprises automatically decreasing the browse speed when media files of a type associated with the desired media file are within the media view and increasing the browse speed when media files of a type associated with the desired are not within the media view.
